(19) United States
(12) Patent Application Publication
(10) Pub. No.: US 2025/0332732 A1
(43) Pub. Date: Oct. 30, 2025

(54) Method and apparatus for assessing the degree of damage to objects at disaster sites using skeletonization techniques

(71) Applicant: NATIONAL DISASTER MANAGEMENT RESEARCH INSTITUTE, Ulsan (KR)

(72) Inventors: Seong Sam Kim, Ulsan (KR); Jae-Wook Seok, Ulsan (KR); Yong-Han Jung, Ulsan (KR); Eon-Taek Lim, Ulsan (KR); Seul Koo, Ulsan (KR); Cheol Kyu Lee, Ulsan (KR)

(21) Appl. No.: 19/184,494

(22) Filed: Apr. 21, 2025

(30) Foreign Application Priority Data
Apr. 24, 2024 (KR) 10-2024-0054808

(51) Int. Cl. B25J 9/16; B25J 19/02; G06T 7/00

(52) U.S. Cl. CPC B25J 9/1697; B25J 19/021; G06T 7/0004; G06T 2207/20044; G06T 2207/30132

(57) ABSTRACT

The present disclosure relates to a method for assessing the degree of damage to objects at disaster sites using skeletonization techniques, including the steps of moving a position of an investigation robot for information analysis of facility in a disaster site space to a first location by using a sensor module equipped in the investigation robot and including at least one of a LiDAR sensor, an IMU sensor or at least one vision sensor; acquiring sensing information corresponding to the first location based on SLAM; identifying a facility segment of a first space based on the sensing information; acquiring visual crack identification information corresponding to the facility segment, analyzed from vision image information of the sensing information, and unit crack information corresponding to the visual crack identification information; determining a crack expansion risk corresponding to the unit crack information.

### CROSS-REFERENCE TO RELATED APPLICATION

This application claims priority to Korean Patent Application No. 10-2024-0054808, filed on Apr. 24, 2024, and all the benefits accruing therefrom under 35 U.S.C. § 119, the contents of which in its entirety are herein incorporated by reference.

### BACKGROUND

### 1. Field

Embodiments of the present disclosure relate to a method and apparatus for assessing disaster sites, and more particularly, to a method and apparatus for assessing the degree of damage to objects at disaster sites using skeletonization techniques.

### 2. Description of the Related Art

The objective investigation of causes and damages at disaster sites plays a critical role in the prevention of disasters and the establishment of effective response strategies. In recent years, advanced technological equipment-such as drones, robots, and specialized vehicles has been actively utilized for such purposes. In particular, tracked ground survey robots have proven to be highly effective as disaster investigation tools, especially in acquiring indoor survey data at earthquake or structural collapse sites, and in replacing human investigators in high-risk collapse areas.

These disaster investigation robots are typically equipped with positioning modules, LiDAR sensors, camera sensors, and communication modules. They perform tasks such as predicting and reporting potential structural collapse risks by means of indoor and outdoor localization and LiDAR sensing.

However, LiDAR sensors operate by measuring incidents and reflected light to calculate distances to target objects. Accurate measurements require that the sensor module remains stable against vibration. This requirement poses significant challenges in constrained or unstable field environments, where such stability is difficult to ensure.

Moreover, when assessing structural damage, crack detection is one of the most crucial factors. Currently, cracks are analyzed by extracting feature points from camera images and generating a point cloud to identify the overall shape and outline of the crack. However, this method is limited in that it cannot accurately identify the start or end point of the crack. As a result, it becomes difficult to determine whether the feature is truly a crack, and to assess its precise location and size.

In actual disaster environments, real-time structural collapse risks or secondary collapses during recovery operations can cause significant damage. Therefore, there is a growing need for technologies that can accurately assess risk, analyze damage scale, and rapidly deliver analytical results.

Furthermore, even when damage scale is quickly identified, it remains challenging to accurately evaluate or predict collapse risks due to the complexity of indoor and outdoor structural cracks and damages. Accordingly, there is a pressing need for comprehensive evaluation methods at disaster sites, as well as technologies capable of predicting and preventing collapse risks in disaster-prone or maintenance-required structures to minimize potential damage.

### RELATED LITERATURES

### Patent Literatures

(Patent Literature 1) Korean Patent No. 10-2555009 (2023.07.10) [Korea Construction Quality Research Center]

### SUMMARY

The present disclosure is designed to solve the above-described problems, and therefore the present disclosure is directed to providing a method and apparatus for assessing disaster sites using indoor/outdoor spatial information structuring, involving segmenting sensing information observed by a sensor module of an investigation robot according to visual features of vision sensor information to identify a crack, determining a corresponding LiDAR sensor-based depth change to calculate and visualize more accurate crack location, the presence or absence of crack and the crack scale for each crack, and structuring indoor/outdoor spatial information on the unit crack basis using the visualized data, thereby assessing the degree of damage or the collapse risk of facilities in a rapid and optimized manner.

The problems to be solved are not limited to the above-described problems, and may be expanded to various problems that may be derived by the embodiments of the present disclosure described below.

The present invention provides a method for assessing a degree of damage to objects at disaster sites using skeletonization techniques, and a computer program for executing the method.

According to one aspect of the invention, there is provided a method comprising the steps of moving an investigation robot having a sensor module to a first location to analyze information of a facility in a disaster site space, the sensor module including at least one of a LiDAR sensor, an Inertial Measurement Unit (IMU) sensor, or at least one vision sensor; acquiring sensing information corresponding to the first location based on simultaneous localization and mapping (SLAM); identifying a facility segment of a first space based on the sensing information; acquiring visual crack identification information corresponding to the facility segment, the visual crack identification information being analyzed from vision image information of the sensing information; acquiring unit crack information corresponding to the visual crack identification information; determining a crack expansion risk corresponding to the unit crack information; and forming disaster site assessment information of the first space using the crack expansion risk and outputting the disaster site assessment information to at least one device.

In the above method, the step of acquiring the unit crack information comprises the step of extracting a unit crack image distinguished by a branch point, using a reference crack line acquired by skeletonization processing from a crack image from which the visual crack identification information is extracted. The investigation robot further comprises a light irradiation device configured to irradiate at least two lights onto the crack. The unit crack image includes an image in which a new branch crack line identified by oblique light irradiation is updated in an area where the reference crack line is determined by vertical light irradiation onto the crack. The light irradiation device is configured to successively perform the oblique light irradiation onto the area where the reference crack line is determined.

In some embodiments, the step of determining the crack expansion risk comprises the step of determining the crack expansion risk based on a density of branch points.

In another embodiment, the crack expansion risk is determined according to a width and size of the reference crack line and a width and size of the branch crack line identified corresponding to the reference crack line.

In yet another embodiment, the step of determining the crack expansion risk comprises the steps of determining crack type information corresponding to the unit crack image and acquiring the crack expansion risk by inputting the crack type information and array information between unit crack images to a learning model pre-trained with crack risk. A training parameter of the learning model includes feature information for each cracked indoor/outdoor space facility object, so as to differently assess the crack expansion risk for a same crack type and array depending on the structural context.

In further embodiments, the investigation robot includes a mist sprayer to spray at least one mist onto the crack. In such cases, the unit crack image includes an image in which a new reference crack line or a branch crack line identified by spraying the mist is updated in the area in which the reference crack line is determined.

The step of outputting to the at least one device may further comprise the step of determining a collapse risk for the facility segment of the first space corresponding to the unit crack information and forming and outputting the disaster site assessment information including the determined collapse risk.

The present invention also provides a computer program stored in a computer-readable medium that enables a computer to perform the method defined in any one of the embodiments.

According to an embodiment of the present disclosure, the position of the investigation robot for facility information analysis may be moved to the first location, visual crack identification information of the facility segment may be extracted from vision image information, and crack depth change information determined by depth sensing information corresponding to the visual crack identification information may be acquired and used to determine the presence or absence of crack and the crack scale, based on which estimation calculation of the degree of damage to the facility segment may be performed.

Further, according to an embodiment of the present disclosure, the crack analysis unit to acquire the unit crack information corresponding to the visual crack identification information, and determine the crack expansion risk corresponding to the unit crack information; and disaster site assessment information of the first space may be formed using the crack expansion risk and outputted to one or more devices.

Accordingly, the present disclosure may provide the method and apparatus for assessing disaster sites using indoor/outdoor spatial information structuring for improving crack prediction accuracy as well as assessing the degree of damage or the collapse risk of facilities in a rapid and optimized manner by obtaining the degree of damage and crack analysis result of the facility visualized to allow the operator to easily perceive in an intuitive manner, and structuring the indoor/outdoor spatial information on the unit crack basis using the visualized data.

Therefore, the present disclosure may provide the method for assessing disaster sites for preventing the collapse risks of indoor/outdoor facilities in real time in actual disaster environments or additional collapse risks during the recovery work, and accurately assessing the collapse risks, thereby minimizing damage in disaster situations or facilities requiring maintenance and repair, and its applications for collapse risk prediction and prevention.

It should be understood that the effects of the present disclosure are not limited to the above-described effects, and may be expanded to various effects that may be derived from the following detailed description of the embodiments of the present disclosure.

### BRIEF DESCRIPTION OF THE DRAWINGS

FIG. 1 is a diagram showing an example of an operating environment of a system according to an embodiment of the present disclosure.

FIG. 2 is a block diagram illustrating the internal configuration of a computing device 200 according to an embodiment of the present disclosure.

FIG. 3 is a diagram illustrating the hardware configuration of an investigation robot connected to a computing device according to an embodiment of the present disclosure.

FIG. 4 is an exemplary diagram of a sensor module according to an embodiment of the present disclosure.

FIG. 5 is an exemplary diagram of a damage information processing unit according to an embodiment of the present disclosure.

FIG. 6 is a detailed block diagram showing a crack analysis unit according to an embodiment of the present disclosure.

FIG. 7 is a detailed block diagram showing a damage information detection unit according to an embodiment of the present disclosure.

FIG. 8 is a flowchart illustrating the operation of a computing device according to an embodiment of the present disclosure.

FIG. 9 is a detailed flowchart illustrating a damage detection algorithm according to an embodiment of the present disclosure.

FIG. 10 is a diagram illustrating an example of implementation of a damage information providing process according to an embodiment of the present disclosure.

FIG. 11 is an exemplary analysis diagram illustrating a crack skeletonization and scale estimation method according to an embodiment of the present disclosure.

FIGS. 12 and 13 show experimental examples of testing crack detection performance for each viewing angle and distance from crack according to an embodiment of the present disclosure.

FIG. 14 is a diagram illustrating a damage information calculation and collapse risk prediction process according to another embodiment of the present disclosure.

FIG. 15 is an exemplary diagram illustrating a crack expansion risk calculation process based on unit crack identification according to an embodiment of the present disclosure.

FIGS. 16A and 16B are diagrams illustrating a unit crack image extraction process based on light irradiation according to another embodiment of the present disclosure.

FIG. 17 is a diagram showing a visualization segment according to an embodiment of the present disclosure and visualized collapse risk analysis result for each unit crack.

FIGS. 18A, 18B and 18C are diagrams illustrating an analysis process for assessing the degree of damage.

FIG. 19 is a diagram illustrating experimental data for learning-based implementation of an embodiment of the present disclosure.

### DETAILED DESCRIPTION

In describing an embodiment of the present disclosure, when a certain detailed description of well-known elements or functions is determined to make the subject matter of an embodiment of the present disclosure ambiguous, the detailed description is omitted. Additionally, in the drawings, elements irrelevant to the description of an embodiment of the present disclosure are omitted, and like reference signs are affixed to like elements.

In an embodiment of the present disclosure, when an element is referred to as being “connected”, “coupled” or “linked” to another element, this may include not only a direct connection relationship but also an indirect connection relationship in which intervening elements are present. Additionally, unless expressly stated to the contrary, “comprise” or “include” when used in this specification, specifies the presence of stated elements but does not preclude the presence or addition of one or more other elements.

In an embodiment of the present disclosure, the terms “first”, “second” and the like are used to distinguish an element from another, and do not limit the order or importance between elements unless otherwise mentioned. Accordingly, a first element in an embodiment may be referred to as a second element in other element within the scope of embodiments of the present disclosure, and likewise, a second element in an embodiment may be referred to as a first element in other embodiment.

In an embodiment of the present disclosure, the distinguishable elements are intended to clearly describe the feature of each element, and do not necessarily represent the separated elements. That is, a plurality of elements may be integrated into one hardware or software, and an element may be distributed to multiple hardware or software. Accordingly, although not explicitly mentioned, the integrated or distributed embodiment is included in the scope of embodiments of the present disclosure.

In the specification, a network may be a concept including a wired network and a wireless network. In this instance, the network may refer to a communication network that allows data exchange between a device and a system and between devices, and is not limited to a particular network.

The embodiment described herein may have aspects of entirely hardware, partly hardware and partly software, or entirely software. In the specification, “unit”, “apparatus” or “system” refers to a computer related entity such as hardware, a combination of hardware and software, or software. For example, the unit, module, apparatus or system as used herein may be a process being executed, a processor, an object, an executable, a thread of execution, a program and/or a computer, but is not limited thereto. For example, both an application running on a computer and the computer may correspond to the unit, module, apparatus or system used herein.

Additionally, the device as used herein may be a mobile device such as a smartphone, a tablet PC, a wearable device and a Head Mounted Display (HMD) as well as a fixed device such as a PC or an electronic device having a display function. Additionally, for example, the device may be an automotive cluster or an Internet of Things (IoT) device. That is, the device as used herein may refer to devices on which the application can run, and is not limited to a particular type. In the following description, for convenience of description, a device on which the application runs is referred to as the device.

In the present disclosure, there is no limitation in the communication method of the network, and a connection between each element may not be made by the same network method. The network may include a communication method using a communication network (for example, a mobile communication network, a wired Internet, a wireless Internet, a broadcast network, a satellite network, etc.) as well as near-field wireless communication between devices. For example, the network may include all communication methods that enable networking between objects, and is not limited to wired communication, wireless communication, 3G, 4G, 5G, or any other methods. For example, the wired and/or wireless network may refer to a communication network by at least one communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VOIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) or communication using ultrasonic waves, but is not limited thereto.

The elements described in a variety of embodiments are not necessarily essential, and some elements may be optional. Accordingly, an embodiment including some of the elements described in the embodiment is also included in the scope of embodiments of the present disclosure. Additionally, in addition to the elements described in a variety of embodiments, an embodiment further including other elements is also included in the scope of embodiments of the present disclosure.

Hereinafter, embodiments of the present disclosure will be described in detail with reference to the accompanying drawings.

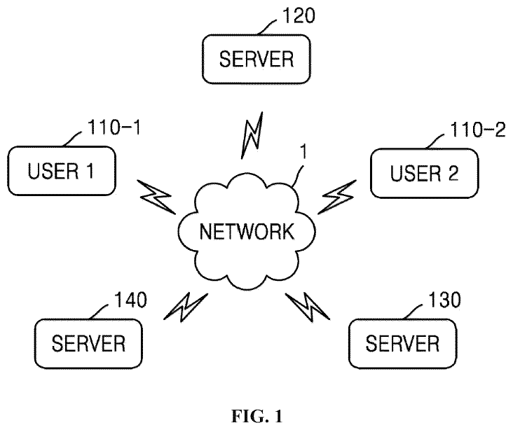

FIG. 1 is a diagram showing an example of a working environment of a system according to an embodiment of the present disclosure. Referring to FIG. 1, a user device 110 and one or more servers 120, 130, 140 are connected via a network 1. FIG. 1 is provided by way of example, and the number of user devices or servers is not limited thereto.

The user device 110 may be a fixed or mobile terminal implemented as a computer system. The user device 110 may include, for example, a smart phone, a mobile phone, a navigation, a computer, a laptop computer, a digital broadcasting terminal, a Personal Digital Assistant (PDA), a Portable Multimedia Player (PMP), a tablet PC, a game console, a wearable device, an internet of things (IoT) device, a virtual reality (VR) device and an augmented reality (AR) device. For example, in the embodiments, the user device 110 may refer to, in substance, one of a variety of physical computer systems that can communicate with the servers 120-140 via the network 1 using a wireless or wired communication method.

Each server may be implemented as a computer device or a plurality of computer devices which provide instructions, code, files, content and services by communication with the user device 110 via the network 1. For example, the server may be a system which provides each service to the user device 110 connected via the network 1. As a more specific example, through an application as a computer program installed and running on the user device 110, the server may provide the user device 110 with a service (for example, information provision, etc.) intended by the corresponding application. As another example, the server may distribute files for installing and running the above-described application to the user device 110, receive user input information and provide a corresponding service.

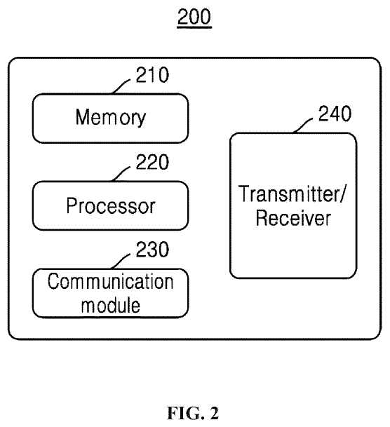

FIG. 2 is a block diagram illustrating the internal configuration of a computing device 200 in an embodiment of the present disclosure. The computing device 200 may be applied to the user device 110 or the servers 120-140 described above with reference to FIG. 1, and each device and the servers may have identical or similar internal configuration by adding or subtracting some components.

Referring to FIG. 2, the computing device 200 may include a memory 210, a processor 220, a communication module 230 and a transmitter/receiver 240. The memory 210 is a non-transitory computer-readable recording medium, and may include a permanent mass storage device such as random access memory (RAM), read only memory (ROM), disk drive, solid state drive (SSD) and flash memory. Here, the permanent mass storage device such as ROM, SSD, flash memory and disk drive is a separate permanent storage device that is different from the memory 210 and may be included in the above-described device or server. Additionally, the memory 210 may store an operating system and at least one program code (for example, code for browsers installed and running on the user device 110 or applications installed on the user device 110 to provide particular services). These software components may be loaded from a separate computer-readable recording medium that is different from the memory 210. The separate computer-readable recording medium may include a computer-readable recording medium such as floppy drive, disk, tape, DVD/CD-ROM drive and a memory card.

In another embodiment, the software components may be loaded onto the memory 210 through the communication module 230, but not the computer-readable recording medium. For example, at least one program may be loaded onto the memory 210 based on a computer program (for example, the above-described application) installed by files provided by developers or a file distribution system (for example, the above-described server) responsible for distributing an installation file of the application via the network 1.

The processor 220 may be configured to process the instructions of the computer program by performing basic operations such as arithmetic, logic and input/output operations. The instructions may be provided to the processor 220 by the memory 210 or the communication module 230. For example, the processor 220 may be configured to execute the received instructions according to the program code stored in the recording device such as the memory 210.

The communication module 230 may provide a function of allowing the user device 110 and the servers 120-140 to communicate with each other via the network 1, and a function of allowing each of the device 110 and/or the servers 120-140 to communicate with another electronic device.

The transmitter/receiver 240 may be a means for interfacing with an external input/output device (not shown). For example, the external input device may include a keyboard, a mouse, a microphone and a camera, and the external output device may include a display, a speaker and a haptic feedback device.

As another example, the transmitter/receiver 240 may be a means for interfacing with a device having an integrated function for input and output such as a touchscreen.

Additionally, in other embodiments, the computing device 200 may include a larger number of components than the components of FIG. 2 according to the nature of a device to which the computing device 200 is applied. For example, when the computing device 200 is applied to the user device 110, the computing device 200 may be implemented to include at least some of the above-described input/output devices, or may further include other components such as a transceiver, a Global Navigation Satellite System (GNSS) module, a camera, a variety of sensors and a database. As a more specific example, when the user device is a smartphone, the computing device 200 may be implemented to further include various types of components commonly included in smartphones, such as an acceleration sensor or a gyro sensor, a camera module, a variety of physical buttons, buttons using a touch panel, input/output ports and a vibrator for vibration.

The computing device 200 described above may be realized by a device including a processor and a memory. The memory may store instructions, and the processor may perform the operations described hereinafter based on the instructions stored in the memory. The device according to the present disclosure may be implemented by at least a part of the configuration illustrated in FIG. 1 or FIG. 2.

Hereinafter, the operation of a computing device will be described with reference to FIGS. 1 and 2. As an example, hereinafter, a user may communicate with a robot 300 based on the computing device 200. In addition, hereinafter, the robot 300 may be a device connected to one computing device 200 to communicate with an external device. As a specific example, the robot 300 may communicate with another device or a server via a network, and include the components of the computing device 200 of FIG. 2. In addition, the robot 300 may include a sensor to identify a surrounding image or video, and it will be described below.

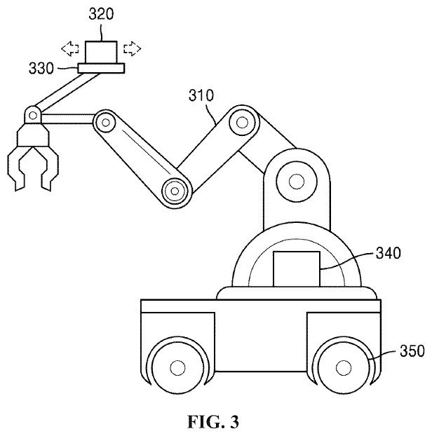

FIG. 3 is a diagram illustrating the hardware configuration of the investigation robot connected to the computing device according to an embodiment of the present disclosure.

Referring to FIG. 3, the robot 300 may include a multisensor 320 including at least one sensor, a header 330 capable of fine adjustment and light source formation and used to couple the multisensor 320, and a robot arm 310 to which the multisensor 320 is connected by a connector means, and may be configured to perform indoor structure analysis.

Here, the robot arm 310 may be designed to rotate 360° and may be folded and extended.

In addition, the robot 300 may include, at the lower part, a control unit 340 to control the hardware of the robot and power and communication, and a movement unit 350 to control the movement means during movement, so as to make a movement for structure damage analysis in indoor environments in the event of disasters. For example, the movement unit 350 may include wheels or any other component that performs the function of moving in indoor/outdoor spaces, and is not limited to a particular type.

As described above, the robot 300 may be configured to move in indoor/outdoor spaces, and have a communication function to collect various information and transmit it to another device or a server. In addition, the robot 300 may include the multisensor 320 to acquire sensing information. Here, the multisensor 320 may include a LiDAR sensor, an Inertial Measurement Unit (IMU) sensor, a vision camera, a depth camera, a gyro sensor and any other sensors for sensing surrounding information, and is not limited to a particular sensor.

The LiDAR sensor may be a sensor that measures reflector location coordinates by sending a laser pulse and measuring the time taken for the pulse to reflect and return. In addition, the IMU sensor may be a motion sensor that measures the orientation, acceleration and position of a device by measuring the speed, direction and magnetic field through a speedometer, a gyroscope and a magnetometer. In addition, the vision camera may sense image information of surrounding images, and the depth camera may be a sensor that measures or senses 3-dimensional (3D) images (i.e., depth images) of nearby objects based on stereo vision or time of flight (ToF). Other sensors may include sensors for sensing temperature, air pressure and surroundings, and are not limited to a particular embodiment.

As an example, the robot 300 may include the LiDAR sensor (or module) for indoor positioning and mapping. Here, the LiDAR sensor may be made in a small size and coupled to the robot 300. In particular, the LiDAR sensor may work based on Simultaneous Localization And Mapping (SLAM) to produce indoor maps in real time, thereby enabling indoor structure recognition.

In addition, as an example, a global navigation satellite system (GNSS) may be used for indoor/outdoor positioning at disaster sites. However, in disaster sites where indoor communication and radio wave connection from the outside fails due to building shielding and damage, self-positioning and mapping in indoor/outdoor spaces is necessary, and to this end, the robot 300 may include the camera and the LiDAR sensor as the multisensor 320. In this instance, as an example, because of measuring the time based on ToF, the LiDAR sensor may be sensitive to vibration caused by external factors. In view of this fact, the multisensor 320 may include the IMU sensor to sense movement and vibration values of the robot 300 that in turn, moves the position, taking vibration and analysis accuracy into account, thereby achieving stable crack detection and damage information analysis.

As described above, the multisensor 320 may include the sensors to help the robot 300 perform sensing in indoor structures collapsed by earthquake, and the sensing information is not limited to a particular embodiment. For convenience of description, the following description is based on the sensing operation through the multisensor 320 coupled to the robot 300 for the robot 300 to analyze indoor structures. That is, the robot 300 described below may be the robot 300 including the multisensor 320, and may not be limited to a particular embodiment.

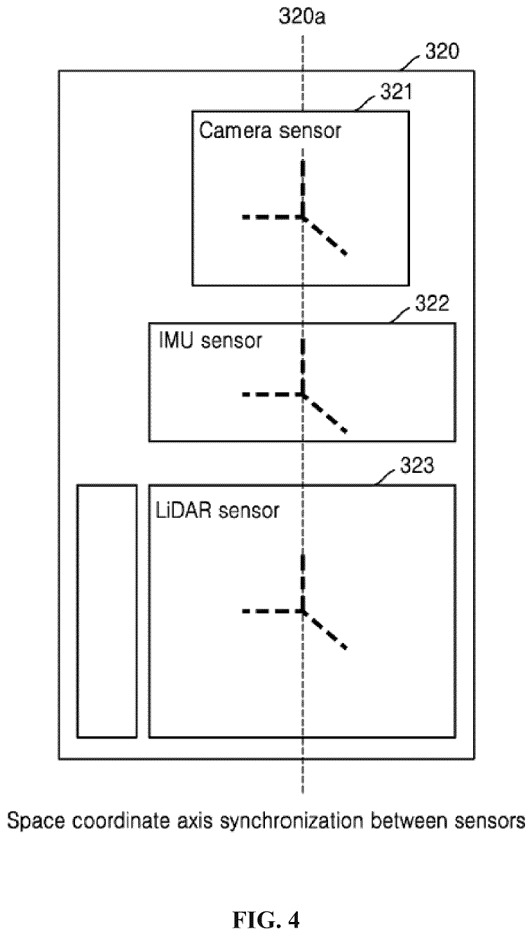

FIG. 4 is an exemplary diagram of the sensor module mounted on the robot 300 according to an embodiment of the present disclosure, showing the hardware configuration of the multisensor 320.

Referring to FIG. 4, the multisensor 320 according to an embodiment of the present disclosure may include the camera sensor 321 on top, the IMU sensor 322 axially coupled to the bottom of the camera sensor 321 and the LiDAR sensor 323 axially coupled to the bottom of the IMU sensor 322.

Here, each sensor module of the multisensor 320 may be physically coupled to each other with respect to a main axis 320a that vertically passes through each module to synchronize 3D space sensing coordinate axes.

By the coordinate axis synchronization of the multisensor 320, as the robot 300 moves and climbs slopes, positioning and rotation information may be processed in real time and reflected in the acquired sensing information of the multisensor 320. For example, the output of each sensor module acquired by the coordinate axis synchronization may be mapped to position information with respect to the synchronized main coordinate axis information, and the image information, the depth sensing information, the rotation information, the angle information, the acceleration information and the vibration information acquired in synchronization from each sensor module may be mapped to the position information and used to track the position of the robot 300 and detect damage to facilities in indoor/outdoor spaces.

In addition, to ease the sensing information processing of the multisensor 320, it is preferable to use SLAM-based data processing. The SLAM is a technology that estimates a location using various sensors in an unknown environment and produces a 3D map of the environment, and has a wide range of applications with increasing computer processing speed and development of sensor technology such as camera and LiDAR, and is used for indoor positioning and mapping, especially when there are no prior maps at disaster sites, to create spatial information through LiDAR and camera-based scanning, data structuring and 3D indoor map visualization.

Accordingly, the robot 300 may build a 3D indoor map by the processing of the sensing information from the multisensor 320 into data, then detect assumed facilities in the indoor map and the degree of damage for each facility based on crack analysis and share the same. For example, the robot 300 may move into an indoor structure collapsed by earthquake, create spatial information based on the robot's location in the structure, and analyze and output the degree of damage for each facility.

In this instance, the indoor structure collapsed by earthquake may be, for example, a harsh environment, and the sensing accuracy may be increased by using data in the preset harsh condition as described below. That is, given the environment of the indoor structure collapsed by earthquake, the robot 300 may move indoors and perform sensing through the sensors. Here, the harsh condition may include, for example, conditions classified into flat ground, speed bumps and gravel, detected by average acceleration and maximum acceleration sensing.

The robot 300 and the multisensor 320 may be controlled by the computing device 200 according to an embodiment of the present disclosure. As an example, the robot 300 may perform indoor positioning and mapping and damage analysis using SLAM based on the multisensor 320, and the robot 300 may be controlled by the connected computing device 200. As an example, the robot 300 and the computing device 200 may exchange information through communication connection between them. In this instance, the robot 300 may perform sensing in indoor/outdoor spaces based on the control operation of the computing device 200, and the computing device 200 may control the position of the multisensor 320 or the movement of the movement unit 350 in real time to increase the accuracy of crack detection.

For example, vibration for sensitivity of the LiDAR sensor or light source environment for image capture of the camera may differ depending on situations at disaster sites. Accordingly, distortion may occur in the sensing information, and a variety of computing processes for minimizing the distortion may be processed by the computing device 200 into a control signal for the robot 300.

As an example, indoor positioning and rotation of the multisensor 320 equipped in the robot 300 may be controlled by the operation control of the robot arm 310 by the computing device 200.

In addition, as an example, the computing device 200 may play a role in controlling the operation of the header 330 coupled to the multisensor 320 to achieve more accurate sensing operation by fine adjustment to the position of the sensor modules of the multisensor 320 and light source control of light-emitting diode (LED) lighting attached to the header 330.

Further, the computing device 200 may control the movement location and speed of the robot 300, and the movement location and speed may be optimized to prevent distortion or errors, taking into account the vibration sensing and the recognition rate of the vision sensor with changes in indoor environments.

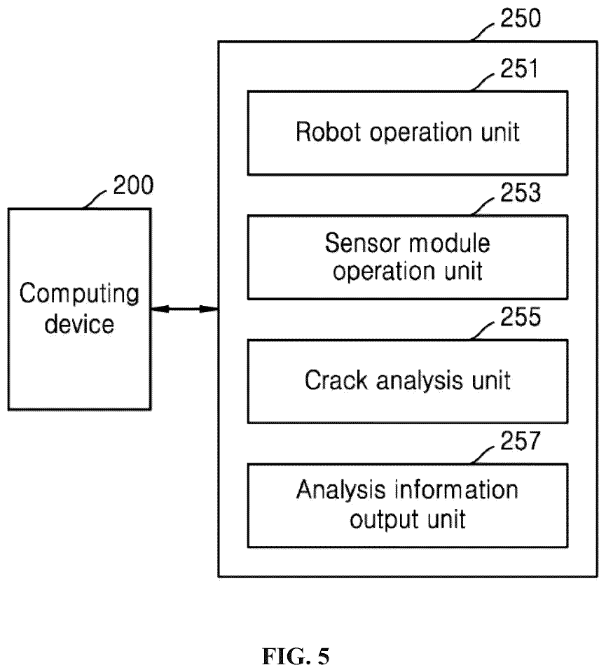

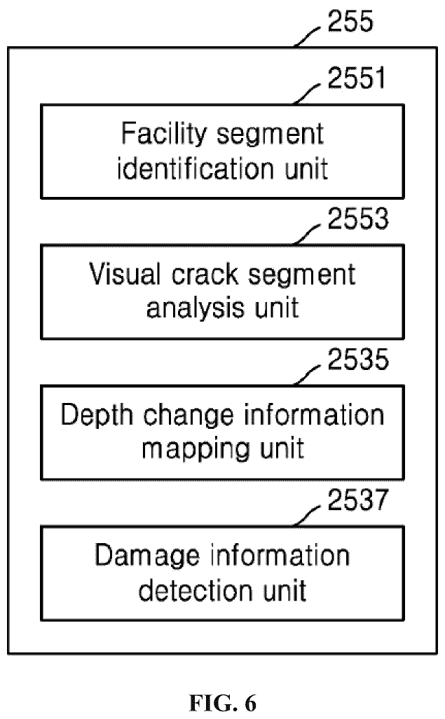

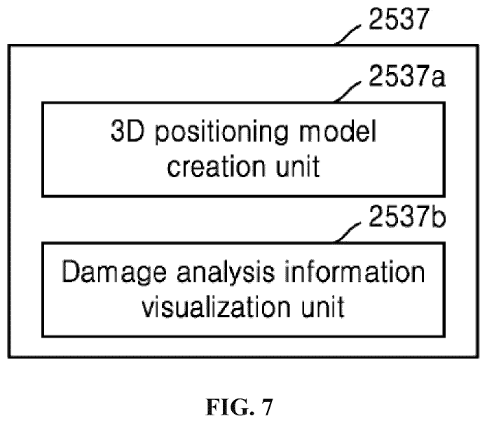

FIG. 5 is a detailed block diagram showing a service processing unit 250 of the computing device 200 for outputting facility analysis information corresponding to indoor/outdoor space 3D analysis by the operation of the robot 300 according to an embodiment of the present disclosure, FIG. 6 is a detailed block diagram showing a crack analysis unit, and FIG. 7 is a detailed block diagram a damage information detection unit.

Referring to FIG. 5, the computing device 200 according to an embodiment of the present disclosure may further include the service processing unit 250. The service processing unit 250 may include processor modules to perform a variety of service processes for crack analysis, damage detection and robot 300 control data processing according to an embodiment of the present disclosure among logic and input/output processing of a processor 220. The computing device 200 may perform service processing by including the service processing unit 250 within the processor 220 or using processed data from a device including the service processing unit 250 as an external processor, and provide the produced service processing result to a user device 110 or one or more servers 120, 130, 140.

By the above-described processing, the user device 110 or one or more servers 120, 130, 140 may receive the analysis information formed by the operation of the service processing unit 250 according to an embodiment of the present disclosure and display and output it through a display device or use it to transmit and receive data via an external network.

More specifically, referring to FIG. 5, the service processing unit 250 includes a robot operation unit 251, a sensor module operation unit 253, the crack analysis unit 255 and an analysis information output unit 257.

The robot operation unit 251 generates the control signal for controlling the hardware operation to control the position movement and sensing operation of the robot 300 shown in FIGS. 3 and 4 described above, transmits the control signal to the robot 300, and controls the operation in response to the received response.

Here, the robot operation unit 251 may control the operation of each of the multisensor 320, the header 330, the robot arm 310, the control unit 340 and the movement unit 350 of the robot 300, thereby controlling the movement of the robot 300 and the internal position and sensing of the multisensor 320.

In addition, the sensor module operation unit 253 acquires the sensor signal from each sensor of the multisensor 320, and performs SLAM-based processing into the synchronized sensing information for each location and transmits it to the crack analysis unit 255.

Here, the sensor signal may include the sensor signal from the LiDAR sensor 323, the sensor signal from the IMU sensor 322 and the vision sensing signal from the camera sensor 321. In addition, the sensor module operation unit 253 may perform mapping and conversion processing of the signal acquired from each sensor module of the multisensor 320 into SLAM data, and the SLAM data may be transmitted to the crack analysis unit 255.

Here, in addition to the basic sensor signals from the LiDAR sensor 323, the IMU sensor 322 and the camera sensor 321, the SLAM data may further include information that has undergone conversion processing into 3D spatial data.

For example, the SLAM data may further include indoor location coordinate information calculated from the IMU sensor 322, a raw image mapping image acquired from the camera sensor 321, pose information of the camera and the LiDAR calculated by the IMU sensor 322, and feature point cloud information acquired from the raw image.

In addition, when the sensing accuracy of each sensor information is below a threshold, in order to improve the sensing accuracy, the sensor module operation unit 253 may request the robot operation unit 251 to move the position or control accurate positioning of the multisensor 320.

Additionally, the crack analysis unit 255 acquires the information subjected to conversion processing by the sensor module operation unit 253, and performs 3D indoor map building and facility damage detection processing using the acquired sensing information. Here, for damage detection processing, the crack analysis unit 255 may identify a facility segment of the indoor/outdoor space based on the sensing information, acquire visual crack identification information analyzed from the vision image information of the sensing information corresponding to the facility segment and crack depth change information determined by the depth sensing information corresponding to the visual crack identification information, and perform estimation calculation of the degree of damage to the facility segment according to the presence or absence of crack and the crack scale acquired based on the visual crack identification information and the crack depth change information.

Accordingly, the analysis information output unit 257 may form facility information analysis result data of the facility segment based on the degree of damage, combine it with 3D indoor map information and output it to one or more devices. One or more devices may include, for example, the user device 110 or one or more servers 120, 130, 140.

More specifically, referring to FIG. 6, the crack analysis unit 255 includes a facility segment identification unit 2551, a visual crack segment analysis unit 2533, a depth change information mapping unit 2535 and a damage information detection unit 2537.

The facility segment identification unit 2551 performs segmentation of the facility segment from the vision image information acquired from the sensing information, followed by identification and classification processing.

Here, the facility segment identification unit 2551 may perform image classification processing for each facility included in the vision image information captured by the robot 300 using a pre-built artificial neural network deep learning-based image classification model, and separate the classified facility image into individual facility segments.

For example, the vision image may be classified into major category, medium category, small category and detailed item according to each facility. For example, a specific facility in the image may be sub-classified into building (major category), structure (medium category), door (small category) and window (detailed item), and a facility image portion classified into each item may be an individual facility segment separated from the raw image, and the classification information may be labeled.

In addition, the visual crack segment analysis unit 2533 acquires the visual crack identification information from the vision image information acquired from the sensing information, and map the acquired visual crack identification information to the facility segment identified by the facility segment identification unit 2551 to form the visual crack identification information for each facility segment.

Here, the visual crack identification information may be detected by inputting the raw image received from the sensor module operation unit 253 to the artificial neural network-based learning model pre-trained with the facility image and the crack detection result. Here, the learning model is a model configured to, first of all, separate a crack segment caused by damage to the facility, especially cracks, and the artificial neural network learning model such as Deep Convolution Neural Network (DCNN) may be used for the training.

In addition, the visual crack segment analysis unit 2533 may map the crack segment extracted from the raw image to the facility segment, and the crack segment may include crack segments for each facility and be used to delineate cracks in the facility.

Here, in image feature point cloud analysis, the crack analysis unit 2533 according to an embodiment of the present disclosure performs pixel information analysis corresponding to the raw image captured at high resolution, and forms vector image information of cracks connecting pixels, thereby achieving more accurate definition of start point and end point of cracks than shape data of point cloud.

Accordingly, in detecting the crack segment as the visual crack identification information, the visual crack segment analysis unit 2533 may detect a visual crack object area assumed as a crack from the vision image, wherein the corresponding object area may be formed as object information including start point and end point information. The object information may be formed as 3D object information using 3D space coordinate information sensed from the multisensor 320, and used to form 3D model data representing the crack segment.

Additionally, the crack segment may form a color image visualized by mapping color information to each pixel, and the visual crack segment analysis unit 2533 may map, to the crack segment, the color image subjected to color conversion processing for each pixel location using geometric transformation information corresponding to the visual crack object.

Here, the geometric transformation information may be acquired according to the rotation information of the IMU sensor 322 corresponding to the visual crack object and the distance movement information of the robot 300. For example, two-dimensional RGB information of the camera may be corrected according to the 3D rotation information and the distance movement information to make the color information more realistic, taking the light source position into account, thereby achieving intuitive visualization.

Additionally, the visual crack segment analysis unit 2533 may request various operations of the sensor module operation unit 253 to increase the accuracy of crack segment detection.

As an example, the visual crack segment analysis unit 2533 may request the sensor module operation unit 253 to control the zoom-in or zoom-out of the camera of the multisensor 320 when the prediction accuracy of the detected crack segment is equal to or less than a first threshold and equal to or more than a second threshold. Accordingly, it may be possible to determine the presence or absence of crack and the crack scale in an area assumed to be cracked more accurately.

In addition, when the prediction accuracy of the detected crack segment is equal to or less than the first threshold and equal to or more than the second threshold, the visual crack segment analysis unit 2533 may request the robot operation unit 251 to control the movement unit 350 to move the robot 300 to the first location. This is to accurately determine the presence or absence of crack and the crack scale, and when an object assumed as a crack is not clearly visible because of being far away, or the depth error estimate is high due to vibration sensing, the movement to the first location may be made to acquire stable and high-quality images. Accordingly, the presence or absence of crack and the crack scale may be determined more accurately through the position movement to the area assumed to be cracked.

Additionally, for 3D analysis corresponding to the presence or absence of crack and the crack scale, the depth change information mapping unit 2535 may perform visualization of the crack segment corresponding to the crack object and depth change information mapping.

Here, the depth change information mapping unit 2535 may acquire a crack area image corresponding to the visual crack object, and acquire depth change information for each pixel acquired from the multisensor 320 corresponding to the crack area image and perform mapping processing.

Here, the depth change information may be determined from the distance information of the LiDAR sensor 323 or the distance information using the depth camera.

Here, the depth camera may include two or more cameras that simultaneously capture the same object at two or more locations. In this case, preferably, the first camera may be a front camera provided for the movement of the robot 300, and the second camera may be the camera sensor of the multisensor 320.

In addition, the depth camera may be a camera commonly used to sequentially capture images while moving between two or more different locations and detect the depth using a difference between the images. In this case, depth images corresponding to the crack area image from two or more different locations may be sequentially taken by the controlled indoor positioning of the multisensor 320 or position movement of the robot 300, and calculation processing of depth information from the depth images may be performed.

Meanwhile, when the object assumed as the crack is identified from the vision sensor of the multisensor 320, the crack analysis unit 255 may explore an optimal location for acquiring the visual crack identification information and the crack depth change information corresponding to the crack. That is, the crack analysis unit 255 may check a suitable location for the robot 300 to determine the presence or absence of crack and the crack size beforehand from a distance, determine the optimal location for the decision (for example, a location that is at a closest distance and expected to have least vibration), and transmit a movement control request for movement to the corresponding location and sensing to the robot operation unit 251.

For example, the crack analysis unit 255 may explore, as a candidate movement location, one or more locations at which the visual crack identification information and the crack depth change information of the object assumed as the crack may be identified beyond the threshold, among locations to which the investigation robot can move, calculated by the sensing stability prediction of the sensor module of the multisensor 320. Additionally, the robot operation unit 251 may move the investigation robot to the determined first location among the found locations.

Meanwhile, the damage information detection unit 2537 performs estimation calculation of the degree of damage to the facility segment according to the presence or absence of crack and the crack scale acquired based on the visual crack identification information and the crack depth change information. Accordingly, the crack analysis unit 255 may form crack analysis information including the calculated degree of damage and transmit it to the analysis information output unit 257. Accordingly, the analysis information output unit 257 may form facility information analysis result data of the facility segment based on the degree of damage and output it to one or more devices.

More specifically, referring to FIG. 7, the damage information detection unit 2537 includes a 3D positioning model creation unit 2537a and a damage analysis information visualization unit 2537b.

Here, the 3D positioning model creation unit 2537a creates a 3D positioning model of the indoor/outdoor space using the SLAM data-based sensing information acquired from the multisensor 320.

In addition, the damage analysis information visualization unit 2537b may perform visualization processing to display the estimated degree of damage to the facility segment onto the 3D positioning model based on the visual crack identification information and the crack depth change information.

More specifically, the damage analysis information visualization unit 2537b may extract crack skeletonization information that forms the crack corresponding to the crack segment determined as the crack object, determine the crack scale using average crack length and thickness information estimated from the extracted crack skeletonization information, and display the determined crack scale onto the 3D positioning model.

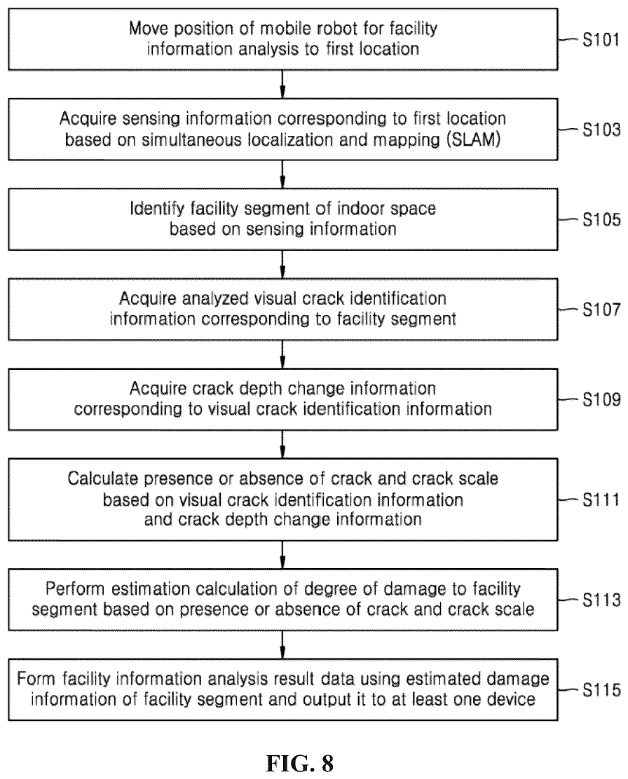

FIG. 8 is a flowchart illustrating the operation of the computing device according to an embodiment of the present disclosure.

Referring to FIG. 8, the computing device 200 including the service processing unit 250 according to an embodiment of the present disclosure moves, through the robot operation unit 251, the position of the investigation robot 300 for facility information analysis to the first location (S101).

Additionally, the computing device 200 acquires, through the sensor module operation unit 253, the sensing information corresponding to the first location based on SLAM (S103).

Subsequently, the computing device 200 identifies, through the crack analysis unit 255, the facility segment of the indoor/outdoor space based on the sensing information (S105).

Additionally, the computing device 200 acquires, through the crack analysis unit 255, the analyzed visual crack identification information corresponding to the facility segment (S107), and acquires the crack depth change information corresponding to the visual crack identification information (S109).

Accordingly, the computing device 200 calculates, through the crack analysis unit 255, the presence or absence of crack and the crack scale based on the visual crack identification information and the crack depth change information (S111), and performs estimation calculation of the degree of damage to the facility segment based on the presence or absence of crack and the crack scale (S113).

Subsequently, the computing device 200 forms, through the analysis information output unit 257, the facility information analysis result data using the estimated damage information of the facility segment and outputs it to one or more devices (S115).

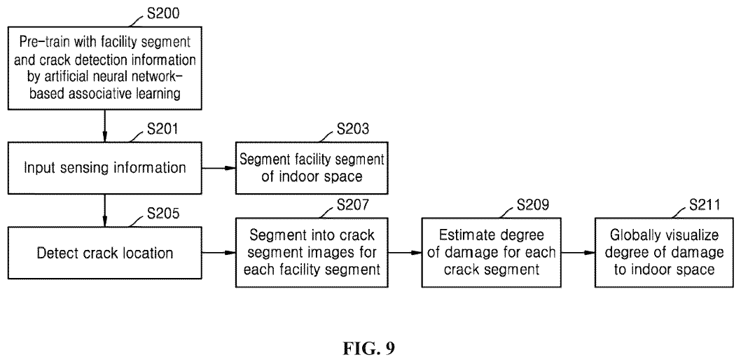

FIG. 9 is a detailed flowchart illustrating a damage detection algorithm according to an embodiment of the present disclosure.

FIG. 9 shows the detailed damage detection algorithm, and the computing device 200 builds the learning model pre-trained with the extracted facility segment in the sensor image and actual crack detection information by artificial neural network-based associative learning (S200).

Here, associative learning for extraction and classification of the facility segment may include, for example, an image classification learning method based on artificial neural network deep learning such as DeepLab, and associative learning for crack detection may include, for example, a DCNN-based artificial neural network learning method involving learning to extract the crack segment image and the crack object from the facility based on ResNet. Accordingly, each of the first learning model for facility segment detection and the second learning model for crack segment extraction may be pre-built.

Additionally, when the sensing information is inputted to the crack analysis unit 255 (S201), the computing device 200 performs segmentation processing of the facility segment image of the indoor/outdoor space using the first learning model (S203).

Subsequently, the computing device 200 detects, through the crack analysis unit 255, the crack location using the second learning model (S205) and performs segmentation processing into crack segment images for each facility segment (S207).

Additionally, the computing device 200 estimates, through the damage degree detection unit 2537 of the crack analysis unit 255, the degree of damage for each crack segment (S209), and globally visualizes and outputs the degree of damage for each facility of the indoor/outdoor space (S211).

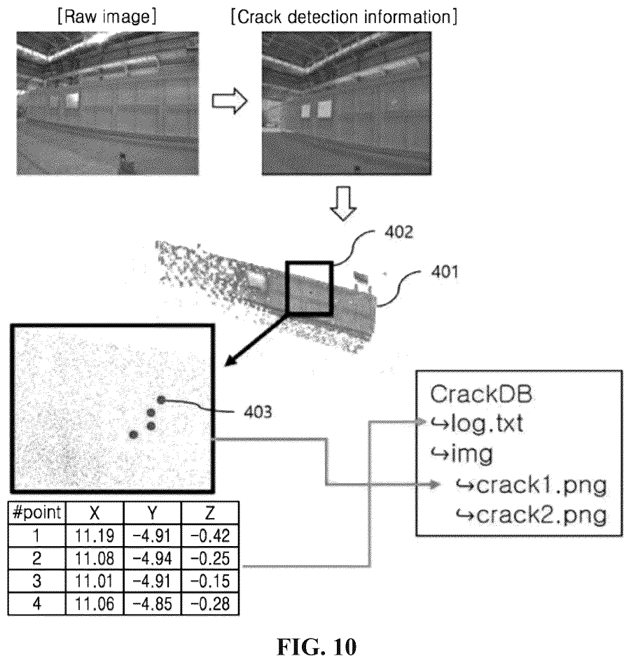

FIG. 10 is a diagram illustrating an example of implementation of a damage information providing process according to an embodiment of the present disclosure.

As shown in FIG. 10, when the raw image information is acquired from the sensor module operation unit 253, the crack analysis unit 255 may perform crack analysis by geometric transformation processing of the color information of the raw image and detection and display of the crack segment corresponding to each facility segment. Each analysis result may be visualized as shown in FIG. 10, followed by 3D modeling, then provided to each of the user device 110 or one or more servers 120, 130, 140.

In particular, as shown in FIG. 10, the location and degree of damage for each facility recognized may be formed as 3D location coordinates and mapped to the visualized 3D analysis result data, and a crack detection area 402 may be displayed on a facility segment model 401, and crack object location coordinates 403 detected as the crack object may be mapped within the crack detection area 402. The detection information may be mapped as detection log data and each individual crack segment image data, and stored and managed in the computing device 200.

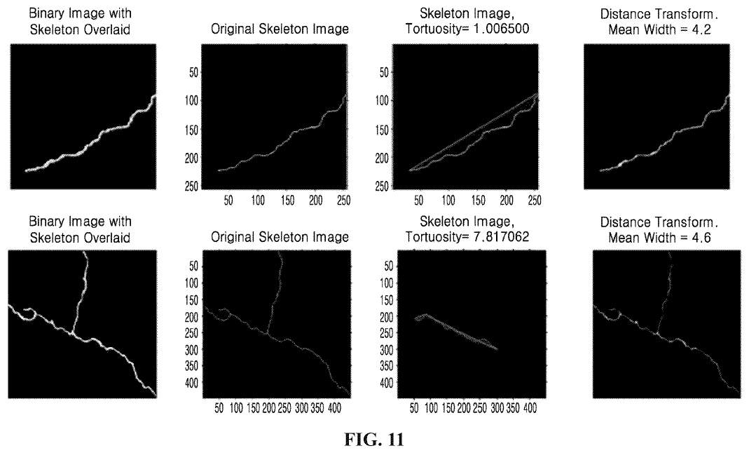

FIG. 11 is an exemplary analysis diagram illustrating a crack skeletonization and scale estimation method according to an embodiment of the present disclosure.

As shown in FIG. 11, the detected crack object information may undergo transformation processing to determine the degree of damage after measuring the average crack length and thickness, and the transformation method may preferably include skeletonization. This is to determine the presence or absence of crack and the crack scale more accurately than the raw crack image, and determine the degree of damage using the estimated value quickly. To estimate the crack scale, binary conversion and vectorization of the crack segment image may be used, and a trend line prediction algorithm may be used.

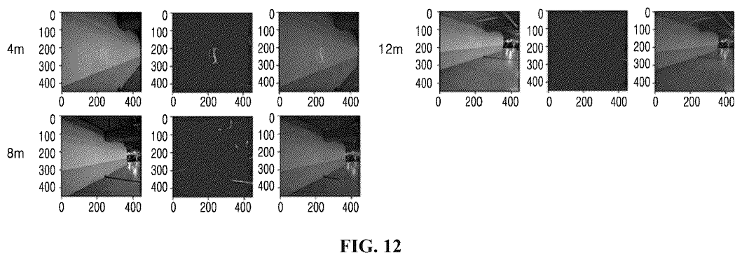

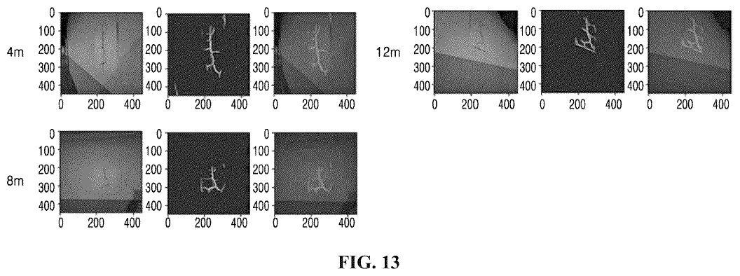

FIGS. 12 and 13 show experimental examples of testing the crack detection performance for each viewing angle and distance from crack according to an embodiment of the present disclosure.

Referring to FIG. 12, it can be seen that as the distance is shorter, the shape of the crack segment is detected more accurately, and referring to FIG. 13, it can be seen that the shape detection and color conversion mapping of the crack segment are performed more accurately by adjusting the viewing angle to see straight the object. As described above, the computing device 200 may determine the optimized first location when the assumed crack object is detected in view of the location for more accurate detection of the shape of the crack segment and vibration minimization, and move the robot 300 to the corresponding location, thereby achieving more accurate crack segment detection, and more accurate crack object and degree of damage analysis.

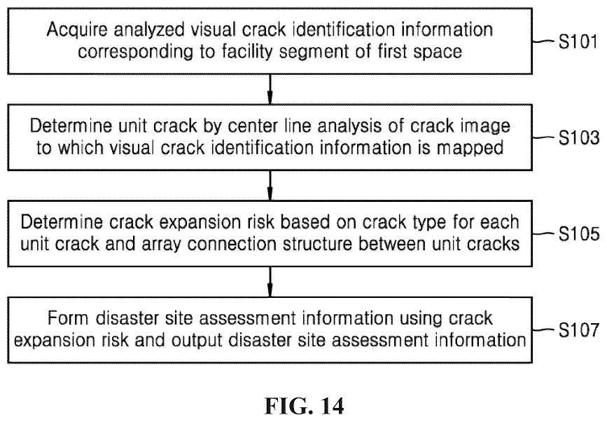

FIG. 14 is a diagram illustrating a damage information calculation and collapse risk prediction process according to another embodiment of the present disclosure.

Referring to FIG. 14, the crack analysis unit 255 according to an embodiment of the present disclosure identifies a unit crack corresponding to a preset size and a pre-learned object shape based on the visual crack identification information and the information associated with the presence or absence of crack and the crack scale analyzed through the damage information detection unit 2537, and calculates an expansion risk for each unit crack to calculate the collapse risk for each spatial structure such as indoor/outdoor facilities, and output it as the collapse risk for each space through the analysis information output unit 257. Here, the facility segment may be expanded to a space segment.

More specifically, the computing device 200 acquires the analyzed visual crack identification information corresponding to the facility segment located in the first indoor/outdoor space through the crack analysis unit 255 (S301).

As described above, the visual crack segment analysis unit 2533 may acquire the visual crack identification information based on the vision image information acquired from the sensing information of the robot 300, and map the acquired visual crack identification information to the facility segment identified by the facility segment identification unit 2551 to form the visual crack identification information for each facility segment. Here, the visual crack identification information may be detected by inputting the raw image received from the sensor module operation unit 253 to the artificial neural network-based learning model pre-trained with the facility image and the crack detection result, and the learning model is a model configured to, first of all, separate a crack segment caused by damage to the facility, especially cracks, and the artificial neural network learning model such as DCNN may be used for the training.

Subsequently, the computing device 200 extracts, through the damage information detection unit 2537, the crack image to which the visual crack identification information corresponding to the first space is mapped, and determines the unit crack for expansion risk assessment by center line analysis of the crack image (S303).

Additionally, the computing device 200 determines, through the damage information detection unit 2537, the crack type for each unit crack based on unit crack image information acquired corresponding to the unit crack, determines an array connection structure between each unit crack corresponding to the determined crack type, and determines the crack expansion risk based on the determined crack type and array connection structure between unit cracks (S305).

Accordingly, the computing device 200 may form, through the analysis information output unit 257, disaster site assessment information using the crack expansion risk from the damage information detection unit 2537, and output the disaster site assessment information to an output device or another device (S307).

For example, because each crack expansion risk is mapped to the spatial information of the indoor/outdoor facility, the analysis information output unit 257 may calculate the collapse risk of each facility using the crack expansion risk, form the disaster site assessment information including the collapse risk, and output it to the pre-designated output device.

According to an embodiment of the present disclosure, this process may predict the collapse risk from the crack expansion likelihood quickly and accurately.

Accordingly, the present disclosure may determine the analysis result or scale of the facility segment of the indoor/outdoor space quickly, predict the collapse risk accurately, and form and provide the disaster site assessment information for minimizing damage in disaster situations or facilities requiring maintenance and repair, thereby preventing the collapse risk quickly and avoiding larger accidents.

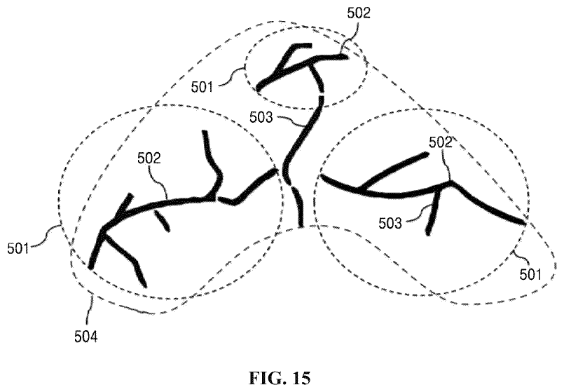

FIG. 15 is an exemplary diagram illustrating the crack expansion risk calculation process based on unit crack identification according to an embodiment of the present disclosure.

Referring to FIG. 15, the extracted facility segment image corresponding to the indoor/outdoor space according to an embodiment of the present disclosure may include the crack image extracted to determine the degree of damage, and may be mapped to first spatial information of a specific location identified by the robot 300.

Additionally, the damage information detection unit 2537 may extract a reference crack line 502 from each crack image. Here, the reference crack line 502 is a line segment image or a line segment vector image extracted as a line representing the center of the crack, and may be extracted on a pixel basis through image skeletonization techniques, or may be extracted as vector data reconstructed to represent the center of the crack by image structuring and pattern identification, and the present disclosure is not limited by the extraction method.

Additionally, a start point and an end point of the reference crack line 502 may be determined according to a preset maximum unit length and pattern type. The damage information detection unit 2537 may extract each unit crack image 501 by extracting a predetermined unit area image including each identified reference crack line 502.

Accordingly, the damage information detection unit 2537 may determine the expansion risk for each unit crack by predicting the crack expansion likelihood corresponding to the unit crack image 501. The crack expansion likelihood may be predicted by the learning model pre-trained with crack training images and expansion crack training images by artificial neural network-based associative learning. Using this, the analysis information output unit 257 may calculate the collapse risk corresponding to the first space location by adding the expansion risk for each unit crack corresponding to the first space location.

As described above, when each unit crack image 501 is determined, the crack expansion risk for collapse risk prediction is calculated, so the crack expansion risk may be determined based on the crack type according to the pattern in each unit crack image 501 and the array connection structure between unit cracks.

For example, referring to FIG. 15, the crack expansion risk may differ depending on the type of pattern in the unit crack image 501, for example, X shape, Y shape or xxx shape, and the crack expansion risk may differ depending on the array 504 connection structure of the unit crack image 501, for example, an L-, X-, triangular or rectangular shaped connection. In addition, the training process for each expansion risk calculation may be performed beforehand, and accordingly training parameter setting and pre-training processes are required.

For example, the analysis information output unit 257 may preset a calculation weight for calculating an additional collapse likelihood from the crack expansion risk. For example, the collapse risk weight may be differently set depending on the characteristics of the facility object of the indoor/outdoor space where the crack occurred. Even though the crack pattern and array are the same, the risk may be differently assessed depending on whether the cracked object is a pillar or a floor, and accordingly, the object feature information may be used as the training parameter for calculating the crack expansion risk.

Meanwhile, the damage information detection unit 2537 may identify a critical branch point of the crack using each reference crack line 502, and quantify and calculate the degree of damage by quantitating the width and size of the crack. For this calculation, the damage information detection unit 2537 may further identify a branch crack line 503 derived from the reference crack line 502 from the unit crack image 501, and quantify and calculate the degree of damage corresponding to the unit crack image 501 by analyzing the width and size of each of the reference crack line 502 and the branch crack line 503.

For this purpose, the damage information detection unit 2537 may identify the unit crack image 501 based on the reference crack line 502 having a greater thickness or depth than a preset reference in the crack image, and extract it as an individual unit crack image 501.

In addition, the damage information detection unit 2537 may determine, as the unit crack image 501, an area including branch crack lines 503 of a predetermined length or less from the reference crack line based on the length of the reference crack line 502. For example, when the reference crack line 502 is 10 cm, the area including the branch crack lines 503 of 5 cm or less from the reference crack line 502 may be determined as the unit crack image 501, and each of the degree of damage and the crack expansion risk may be quantified and calculated.

Accordingly, the analysis information output unit 257 may determine the collapse risk for the facility segment of the space including the unit crack images 501 as a weighted sum value using the quantified values, and form and output the disaster site assessment information.

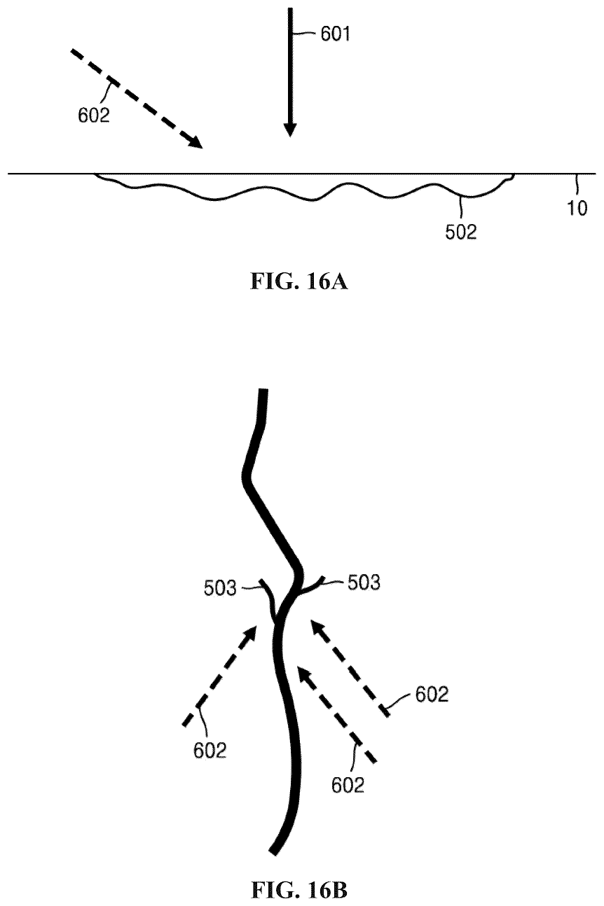

On the other hand, FIG. 16 is a diagram illustrating the unit crack image extraction process based on light irradiation according to another embodiment of the present disclosure.

The robot 300 according to an embodiment of the present disclosure may have a light irradiation device (not shown) commonly used for light irradiation on top or bottom to acquire the vision image information. For example, the light irradiation device may include a laser irradiation device or a light source device such as LED.

Accordingly, referring to FIG. 16, because any crack may not be detected by the image sensor when it is dark, the robot 300 may irradiate light onto the crack area using the light irradiation device, and the branch microcrack lines 503 from the reference crack line 502 may be identified by vertical light 601 or oblique light 602 (preferably 45°) irradiation onto the crack.

FIG. 16 shows light irradiation onto the area at which the same unit crack image 501 is determined, FIG. 16(A) is a side view and FIG. 16(B) is a plan view. The robot 300 may irradiate the oblique light 602 using the light irradiation device onto the reference crack line 502 identified by vertical light 601 irradiation, to newly identify the branch crack lines 503.

Further, in addition to the above-described method, the robot 300 may further have a mist sprayer for crack identification. For example, the mist may include water or liquid having a flame retardant function, and the damage information detection unit 2537 may detect the presence or absence of unidentified microcrack by monitoring the shape in which the sprayed mist gets dry over time after it is adsorbed onto the crack and its surrounding area. To this end, the damage information detection unit 2537 may detect time-series change information for each unit crack image 501, and monitor and update damage information of the unit crack image 501 using the detected change information.

For example, even a fine cracked region may look darker than a non-cracked region because the sprayed liquid permeates the crack, and the fine cracked region gets dry more slowly, so the presence or absence of microcrack corresponding to the reference crack line 502 and the branch crack line 503 in the unit crack image 501 may be additionally determined according to a change in the image.

Here, in assessing the collapse risk based on the unit crack image 501, when assessment reliability is below the threshold due to many complex cracks or external obstacles in the image, the analysis information output unit 257 of the computing device 200 may transmit assessment information to an analysis server (not shown) at a remote location, acquire the analysis result and form the disaster site assessment information. On the contrary, when assessment reliability is above the threshold, the computing device 200 may perform assessment quickly in the process of directly transmitting/receiving the control signal to/from the robot 300 and perform processing of the collapse risk analysis result in real time to form the disaster site assessment information and output it.

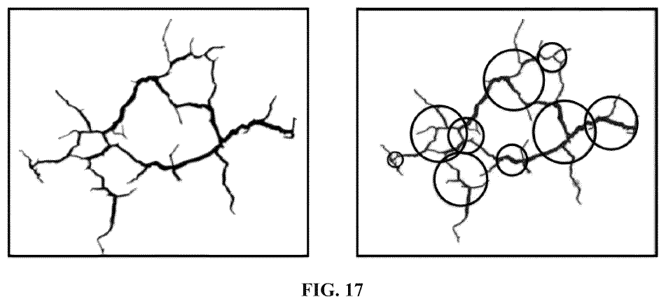

FIG. 17 is a diagram showing a visualization segment according to an embodiment of the present disclosure and the visualized collapse risk analysis result for each unit crack.

FIG. 17(A) shows the extracted crack image corresponding to the visualization segment, and FIG. 17(B) is an image showing unit crack areas classified and identified according to the analysis result, and as shown in FIG. 17, the present disclosure performs classification based on the thickness or depth of each crack, and the unit crack for assessing the degree of damage may be classified and identified using the width and size of each crack line and further using the location and size of a connection point of the crack lines. In particular, as described above, the center line of the crack may be extracted through the skeletonization techniques in the image processing process, and the entire pattern of the crack may be made clear by simplifying the basic structure and extension of the crack. In addition, when the Gaussian Mixture Model (GMM) clustering algorithm is applied, the critical branch point of the crack may be identified, and the branch points indicate the structural importance of the crack and may be important in assessing the complexity of multiple cracks, and accordingly the unit crack may be determined and visualized as shown in FIG. 17(B). For example, a region having the density of branch points higher than the threshold may be classified and identified as a high risk zone.

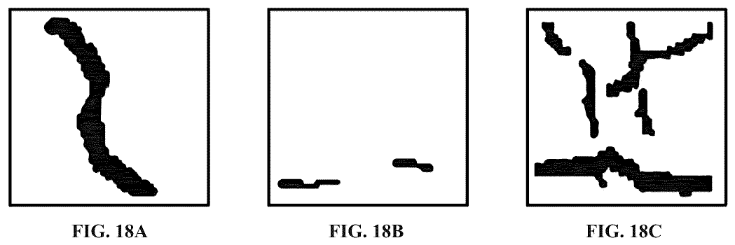

Meanwhile, FIG. 18 is a diagram illustrating an analysis process for assessing the degree of damage.

Referring to FIG. 18, not only the distribution of branch points but also the crack width and size are considered when assessing the degree of damage, and the crack width and size may be written as a ratio of the number of pixels of the degree of damage recognized by the crack to the total number of pixels of the image. Additionally, finally, the ratio indicates the degree of damage in a quantitative manner.

Accordingly, the damage information detection unit 2537 according to an embodiment of the present disclosure may calculate the degree of damage by pre-coded algorithm processing to quantitate the number of pixels of the degree of damage recognized by the crack compared to the total number of pixels of the image. For example, within an area of the same size, the degree of crack may be calculated as 538986 pixels in FIG. 18(A), 4151 pixels in FIG. 18(B), and 42698 pixels in FIG. 18(C), and accordingly the degree of damage may be calculated, and the influence of the crack on the facility may be quantitatively assessed.

In addition, other damage information than the crack, such as the degree of delamination or exposure may be represented in the number of pixels. The delamination refers to separation of surface or layers in a material, and the exposure refers to the exposure of the internal structure of a facility to the outside. The degree of damage may be acquired in a quantitative manner by calculating the number of pixels in the damaged area compared to the entire image. The quantitative analysis provides an important standard in understanding the degree of damage to the facility more clearly and determining necessary repair and reinforcement measures. The algorithm for the degree of damage visualization may be used for emergency assessment after disaster situations as well as regular facility inspection, so the damage analysis result may be used as basic data for establishing disaster preparedness plans and preventive maintenance and repair, and contribute to improved safety and life of facilities.

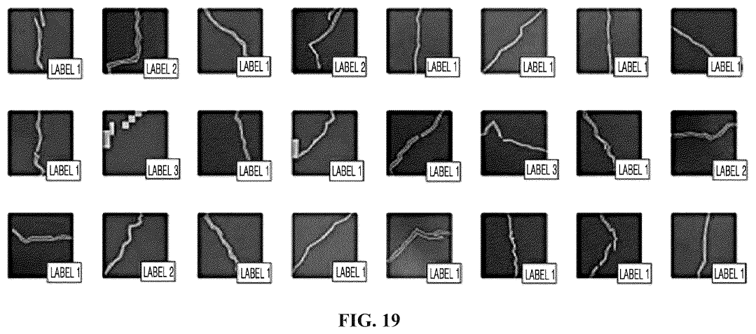

Meanwhile, FIG. 19 is a diagram illustrating experimental data for leaning-based implementation of an embodiment of the present disclosure.

To implement the process for identifying the degree of cracks and damage to facilities according to an embodiment of the present disclosure, the applicant used Ultralytics YOLOv8 program to create new artificial neural network learning datasets, and facility damage images such as cracks and delamination at disaster sites provided from the Disaster and Safety Research Institute were captured and labeled using the bounding box tool Roboflow as shown in FIG. 19.

As shown in FIG. 19, the datasets include cracks images occurred on various surfaces, and the images were taken in various environments, for example, walls, floors, rocks, structures and gaps between ceilings and walls, so in the data collection process, the images directly taken using drones at bridge collapse sites were segmented by frame and labeled to create training data. The on-the-spot collection may play an important role in reflecting the complexity of cracks and damage in the actual disaster situations.

The full dataset used for learning includes a total of 523 images, and among them, 305 images collected in the disaster environment corresponding to approximately 58% of the total dataset were used in the training process, and the remaining 218 images are old house, abandoned building and open crack datasets.

Additionally, the datasets for verification include datasets of a total of 60 images, including 20 images of disaster environments, 20 images of old houses and abandoned buildings and 20 images of open cracks, which accounts for about 33% of the total verification dataset. The data may play an important role in assessing the performance of the learning model.

With the training datasets and the learning model according to an embodiment of the present disclosure, the specialized learning model for unit crack image extraction and damage assessment may be built, and it can be seen that disaster site assessment using the learning model may be performed, and accordingly, it can be seen that the method and apparatus according to an embodiment of the present disclosure may be very useful for predicting and preventing the collapse risk at the actual disaster sites.

The embodiments described hereinabove may be implemented, at least in part, in a computer program and recorded on a computer-readable recording medium. The computer-readable recording medium in which the program for embodying the embodiments is recorded includes any type of recording device in which computer-readable data is stored. Examples of the computer-readable recording medium include ROM, RAM, CD-ROM, magnetic tape, and an optical data storage device. Additionally, the computer-readable recording medium is distributed over computer systems connected via a network, and may store and execute a computer-readable code in a distributed manner. Additionally, a functional program, code and a code segment for realizing this embodiment will be easily understood by persons having ordinary skill in the technical field to which this embodiment belongs.

While the present disclosure has been hereinabove described with reference to the embodiments shown in the drawings, this is provided for illustration purposes only and it will be appreciated by those having ordinary skill in the art that a variety of modifications and variations may be made thereto. However, it should be noted that such modifications fall within the technical protection scope of the present disclosure. Therefore, the true technical protection scope of the present disclosure will be construed as including other implementations, other embodiments and the appended claims and their equivalents by the technical spirit of the appended claims.

What is claimed is:

1. A method for assessing a degree of damage to objects at disaster sites using skeletonization techniques, the method comprising the steps of:
moving an investigation robot having a sensor module to a first location to analyze information of facility in a disaster site space, the sensor module including at least one of a LiDAR sensor, an Inertial Measurement Unit (IMU) sensor or at least one vision sensor;
acquiring sensing information corresponding to the first location based on simultaneous localization and mapping (SLAM);
identifying a facility segment of a first space based on the sensing information;
acquiring visual crack identification information corresponding to the facility segment, analyzed from vision image information of the sensing information, and unit crack information corresponding to the visual crack identification information;
determining a crack expansion risk corresponding to the unit crack information; and
forming disaster site assessment information of the first space using the crack expansion risk and outputting the disaster site assessment information to at least one device,
the step of acquiring the unit crack information comprises the step of:
extracting a unit crack image distinguished by a branch point, using a reference crack line acquired by skeletonization processing from a crack image from which the visual crack identification information is extracted,
wherein the investigation robot has a light irradiation device to irradiate at least two light onto the crack,
wherein the unit crack image includes an image in which a new branch crack line identified by oblique light irradiation is updated in an area where the reference crack line is determined by vertical light irradiation onto the crack, and
wherein the light irradiation device successively performs the oblique light irradiation onto the area where the reference crack line is determined.

2. The method for assessing the degree of damage to objects at disaster sites using skeletonization techniques according to claim 1,
wherein the step of determining the crack expansion risk comprises the step of:
determining the crack expansion risk based on a density of branch points.

3. The method for assessing the degree of damage to objects at disaster sites using skeletonization techniques according to claim 1,
wherein the step of determining the crack expansion risk comprises the step of:
determining the crack expansion risk according to a width and size of the reference crack line and a width and size of the branch crack line identified corresponding to the reference crack line.

4. The method for assessing the degree of damage to objects at disaster sites using skeletonization techniques according to claim 1,
wherein the step of determining the crack expansion risk comprises the steps of:
determining crack type information corresponding to the unit crack image; and
acquiring the crack expansion risk by inputting the crack type information and array information between unit crack images to a learning model pre-trained with a crack risk.

5. The method for assessing the degree of damage to objects at disaster sites using skeletonization techniques according to claim 4,
wherein a training parameter of the learning model includes feature information for each cracked indoor/outdoor space facility object, to differently assess the crack expansion risk for a same crack type and array.

6. The method for assessing the degree of damage to objects at disaster sites using skeletonization techniques according to claim 1,
wherein the investigation robot has a mist sprayer to spray at least one mist onto the crack, and
wherein the unit crack image includes an image in which a new reference crack line or a branch crack line identified by spraying the mist is updated in the area in which the reference crack line is determined.

7. The method for assessing the degree of damage to objects at disaster sites using skeletonization techniques according to claim 1,
wherein the step of outputting to the at least one device comprises the step of:
determining a collapse risk for the facility segment of the first space corresponding to the unit crack information and forming and outputting the disaster site assessment information including the determined collapse risk.

8. A computer program stored in a computer-readable medium to enable a computer to perform the method defined in claim 1.
